(19) United States
(12) Patent Application Publication
(10) Pub. No.: US 2010/0316152 A1
(43) Pub. Date: Dec. 16, 2010

(54) WIRELESS COMMUNICATION APPARATUS AND WIRELESS COMMUNICATION METHOD

(75) Inventor: Shingo Joko, Yokohama-shi (JP)

Correspondence Address: WORKMAN NYDEGGER;1000 Eagle Gate Tower, 60 East South Temple, Salt Lake City, UT, 84111, US

(73) Assignee: KYOCERA CORPORATION, Kyoto-shi, Kyoto (JP)

(21) Appl. No.: 12/867,869

(22) PCT Filed: Feb. 17, 2009
(86) PCT No.: PCT/JP2009/052699

§ 371 Date: Aug. 16, 2010

(30) Foreign Application Priority Data
Feb. 18, 2008 (JP) 2008-036312

(51) Int. Cl. H04L 27/28

(52) U.S. Cl. 375/260

(57) ABSTRACT

A wireless communication apparatus and a wireless communication method, having higher efficiency and reliability than conventional arts, for communication employing OFDMA and a coding scheme are provided. A communication apparatus is provided with a processing unit for performing symbol processing to a communication frame, a detection unit for detecting a value indicating a changing state of a propagation path, a change processing unit for controlling the processing unit to change a symbol to a control symbol based on the value indicating the changing state and a modulation scheme, and a transmission unit for transmitting a communication frame after control to another communication apparatus.

### TECHNICAL FIELD

The present invention relates to wireless communication apparatuses and wireless communication methods employing OFDMA (Orthogonal Frequency Division Multiple Access), and more specifically, to wireless communication apparatuses and wireless communication methods, when transmitting data symbols by using a coding scheme such as STBC (Space Time Block Coding) scheme or SFBC (Space Frequency Block Coding) scheme and an adoptive modulation scheme for a communication with another communication apparatus, capable of improving error durability and communication efficiency, and thus having higher reliability than conventional arts.

### BACKGROUND ART

Wireless communication systems of WiMAX (Worldwide Interoperability for Microwave Access), UMB (Ultra Mobile Broadband), and OFDMA (Orthogonal Frequency Division Multiple Access) scheme (or OFDM (Orthogonal Frequency Division Multiplexing) scheme), which is employed in the next generation PHS and the likes, use multicarrier to improve a communication speed and durability against multipath fading.

For wireless communication using the OFDMA scheme, a transmission side (base station) communicates with a reception side (terminal) by using a frame. FIG. 2 is a diagram illustrating an exemplary frame used in the wireless communication. In the figure, a horizontal axis and a vertical axis indicate time and frequency, respectively. As shown, the frame is composed of a plurality of slots in which data symbols and pilot symbols to be transmitted are arranged in a direction of a time axis and in a direction of a frequency axis. The OFDMA scheme divides an entire area of time to frequency into a predetermined number of groups of symbols called slot (or tile), as shown in the figure, and assigns the slot to a single user. As shown in the figure, the slot is composed of predetermined numbers of data symbols and pilot symbols, which is defined in a standard, and channel estimation, weighting and processing for each symbol (symbol processing, which is described in detail below) are performed for each slot.

In addition, for the wireless communication, numerous transmission diversity schemes have been developed to transmit a single transmission information sequence by using a plurality of transmission antennas so as to enlarge a communication area by reducing undesirable effects of fading and to improve reliability. As a representative transmission diversity scheme, there is STBC (Space Time Block Coding) (see Patent Document 1). As a method to improve mobility mainly, STBC is included in standards such as WiMAX, LTE (Long Term Evolution) and UMB, and Alamouti scheme is particularly well known. Here, STBC is described using Alamouti scheme as an example.

FIG. 24 is a diagram illustrating symbol processing by STBC and shows a part of symbol arrangement included in a slot shown in FIG. 2. Alamouti scheme transmits two symbols adjacent in time by changing combinations thereof for each antenna, as shown in the figure. A combination ST1 of two symbols (s1, s3) adjacent in time in an example of the figure is described (see FIG. 24(a)). As shown in FIG. 24(b), an antenna 1 and an antenna 2 at a transmission side respectively transmit a symbol s1 and a symbol s3 at time 1, and a symbol −s3* and a symbol s1* at time 2. Here, * denotes a complex conjugate number. In a similar manner for a combination ST2 of symbols (s2, s4), the antenna 1 and the antenna 2 at the transmission side respectively transmit a symbol s2 and a symbol s4 at time 1, and a symbol −s4* and a symbol s2* at time 2. A reception side decodes received symbols by using channel information obtained from pilot symbols similarly transmitted from the transmission side.

While STBC scheme changes a combination of symbols in the direction of the time axis, SFBC (Space Frequency Block Code) scheme changes a combination of symbols adjacent in a direction of a frequency axis, and STFBC (space-time-frequency block code) scheme changes a combination of symbols both in the direction of the time axis and in the direction of the frequency axis. Symbol processing by SFBC and STFBC is shown in FIG. 25 and FIG. 26, respectively. SFBC transmits a combination SF1 of two symbols (s1, s2) adjacent in the direction of the frequency axis shown in FIG. 25(a). The antenna 1 and the antenna 2 at the transmission side transmit, respectively, the symbol s1 and the symbol s2 at frequency 1, and a symbol −s2* and the symbol s1* at frequency 2, as shown in FIG. 25(b). STFBC scheme transmits a combination STF1 of four symbols (s1, s2, s3, s4) adjacent in the direction of the time axis and in the direction of the frequency axis, as shown in FIG. 26(a), by using transmission antennas 1 to 4. The antennas 1 to 4 transmit the symbols s1, s2, s3 and s4, respectively, at time 1 and frequency 1. The antennas 1 to 4 also transmit different symbols, respectively, at different combinations of time and frequency.

FIG. 23 is a block diagram illustrating an exemplary communication apparatus (transmission apparatus, base station) of a conventional art for performing communication employing the coding schemes stated above. A communication apparatus 500 is provided with a plurality of antennas (two antennas in the figure) ANT, a transmission and reception unit 510, a control unit 520, and a symbol processing unit 530. The symbol processing unit 530 performs a symbol processing such as STBC stated above. The transmission and reception unit 510 transmits and receives data to/from a reception side (user terminal and the likes) via the antenna ANT. The control unit 520 controls each unit.

In a wireless communication system employing the adaptive modulation scheme, a radio propagation environment (interference, fading and the likes) is monitored and, based on a condition thereof, the modulation scheme (modulation class) of a channel assigned for transmitting and receiving data is adaptively changed. For example, to a terminal moving at a low speed in an area close to the base station and having a good radio propagation path (channel condition), data are transmitted by the modulation scheme of 64-QAM, which is suitable when the received signal strength is high. On the other hand, to a terminal in an area far from the base station and having a poor channel condition or moving at a high speed, data are transmitted by the modulation scheme of BPSK, which is suitable for when the quality of a received signal is low.

In the coding scheme such as STBC stated above, decoding is performed by using channel information estimated using pilot symbols, for example, at the reception side, and thus reliability and accuracy of a communication employing the coding such as STBC and the likes is strongly dependent on accuracy of channel estimation. Therefore, if accuracy of channel estimation is deteriorated because the reception side (user terminal and the likes) moves at a high speed, effects such as fading durability and the likes by coding are reduced. In addition, the higher modulation class is, the higher accuracy of channel estimation is required. That is, even over the same channel, when using 64-QAM the higher accuracy of channel estimation is required than that when using QPSK. On the contrary, in a communication of a modulation class not requiring high accuracy, transmission of more pilot symbols so as to increase accuracy of channel estimation leads waste of a resource (frequency resource). Moreover, although STBC is highly effective for mobility, it has no effect for an idle state.

Although a symbol processing of OFDMA is performed on a slot as a unit, coding such as STBC is required to process two or more symbols adjacent to one another. Accordingly, when coding is performed, if the symbol arrangement in the slot is not optimized for coding, it may cause a problem. That is, when the symbol arrangement in the slot is optimized for transmission by a conventional single antenna which does not perform diversity such as STBC, the symbols cannot be embedded (coding cannot be performed on all symbols in the slot). This is described by using a figure. FIG. 4 is a diagram illustrating a symbol arrangement if STBC is performed on a single slot. As shown, STBC is performed on two symbols adjacent in the direction of the time axis surrounded by bold lines. As a result, symbols represented by ‘R’ become ‘residual symbols’, namely, unprocessed symbols. Such unprocessed symbols waste frequency resources and reduce transmission efficiency and throughput.

As a conventional art to communicate by multicarrier scheme by using STBC and SFBC stated above, Patent Document 2 discloses a method for communication using STBC, when a transmission side or a reception side moves at a high speed under a multipath environment, to perform phase correction on a channel estimation matrix using pilot signals in consideration of moving speed of the transmission side or the reception side, thereby improving accuracy of channel estimation.

Patent Document 1: Japanese Translation of PCT International Application No. 2004-530330

Patent Document 2: Japanese Patent Application Laid-Open No. 2007-081908

### DISCLOSURE OF THE INVENTION

### Problems to be Solved by the Invention

The method of Patent Document 2, however, may not be able to receive pilot signals because of multipath and the high speed movement of the transmission and reception apparatus. In addition, Patent Document 2 does not describe symbol processing in accordance with a required accuracy of channel estimation when the adaptive modulation scheme is employed. It is an object of the present invention to solve the problems stated above and to provide wireless communication apparatuses and wireless communication methods with high reliability, by improving error durability and communication efficiency than those of conventional arts, when employing a coding scheme such as STBC scheme or SFBC scheme and transmitting data symbols by the adaptive modulation scheme.

### SUMMARY OF THE INVENTION

In order to solve such problems, a wireless communication apparatus according to the present invention is a communication apparatus (transmission apparatus) for performing communication (by Orthogonal Frequency Division Multiple Access (OFDMA)) with another communication apparatus by using a communication frame including a plurality of slots, each slot having a plurality of symbols (arranged in a direction of a time axis and in a direction of a frequency axis), and employing an adaptive modulation scheme, including: a processing unit for performing symbol processing (STBC, SFBC, STFBC) for each slot; a detection unit for detecting a value indicating a changing state of a propagation path between the another communication apparatus and the wireless communication apparatus; a change processing unit for controlling the processing unit to change the symbol to a control symbol, based on the value indicating the changing state detected by the detection unit and a modulation scheme (modulation class) in the communication between the another communication apparatus and the communication apparatus; and a transmission unit for transmitting a communication frame after control by the change processing unit to the another communication apparatus.

The communication apparatus according to one embodiment of the present invention is characterized (in being further provided with a memory unit for storing a predetermined value and) in that the change processing unit controls the processing unit to change the symbol to the control symbol if the value indicating the changing state exceeds a predetermined value based on the modulation scheme (modulation class) in the communication between the another communication apparatus and the communication apparatus.

In addition, the wireless communication apparatus according to another embodiment of the present invention is characterized in that the value indicating the changing state is a relative speed between the another communication apparatus and the communication apparatus or a Doppler frequency.

Moreover, the wireless communication apparatus according to yet another embodiment of the present invention is characterized in that the change processing unit controls the processing unit, if there is an unprocessed symbol in a single slot when the symbol processing (STBC, SFBC, STFBC) is performed on the single slot (for each combination of a predetermined number of the symbols) by the processing unit, to change the unprocessed symbol to the control symbol.

Although apparatuses of the present invention is described above, it is to be understood that the present invention may also be achieved by methods, programs, and recording media storing a program, which are substantially equivalent to the apparatuses, and they are included in a scope of the present invention. For data processing, each step of the methods and the program uses an arithmetic processing unit such as CPU, DSP and the likes and stores input data and processed or generated data in a memory device such as HDD, a memory and the likes, as necessary.

For example, a wireless communication method according to yet another embodiment of the present invention achieving the present invention by a method is a communication method of a communication apparatus for performing communication (by Orthogonal Frequency Division Multiplexing (OFDM) or Orthogonal Frequency Division Multiple Access (OFDMA)) with another communication apparatus by using a communication frame including a plurality of slots, each slot having a plurality of symbols, and employing an adaptive modulation scheme, including the steps of: performing symbol processing (STBC, SFBC, STFBC) for each slot; detecting a value indicating a changing state of a propagation path between the another communication apparatus and the communication apparatus; changing the symbol to a control symbol (pilot symbol) based on the value indicating the changing state detected at the step for detecting the value and a modulation scheme in the communication between the another communication apparatus and the communication apparatus; and transmitting a communication frame after control at the step for changing the symbol to the another communication apparatus.

### EFFECT OF THE INVENTION

According to the present invention, it is possible to provide wireless communication apparatuses and wireless communication methods with high reliability, by improving error durability and communication efficiency than those of conventional arts when transmitting data symbols to another communication apparatus by the adaptive modulation scheme employing STBC (Space Time Block Code) scheme or SFBC (Space Frequency Block Code) scheme.

### BRIEF DESCRIPTION OF DRAWINGS

FIG. 1 is a configuration diagram of a wireless communication system and block diagrams of wireless communication apparatuses according to an embodiment of the present invention;

FIG. 2 is a diagram illustrating a frame used for wireless communication;

FIG. 3 is an exemplary flowchart illustrating symbol processing by a communication apparatus according to a first embodiment of the present invention;

FIG. 4 is a diagram illustrating an exemplary symbol arrangement in a slot;

FIG. 5 is a diagram illustrating an exemplary symbol arrangement in the slot;

FIG. 6 is a diagram illustrating an exemplary symbol arrangement in the slot;

FIG. 7 is a diagram illustrating an exemplary symbol arrangement in the slot;

FIG. 8 is a diagram illustrating an exemplary symbol arrangement in the slot;

FIG. 9 is a diagram illustrating an exemplary symbol arrangement in the slot;

FIG. 10 is an exemplary flowchart illustrating symbol processing by a communication apparatus according to a second embodiment of the present invention;

FIG. 11 is a diagram illustrating an exemplary symbol arrangement in a slot;

FIG. 12 is a diagram illustrating an exemplary symbol arrangement in the slot;

FIG. 13 is a diagram illustrating an exemplary symbol arrangement in the slot;

FIG. 14 is a diagram illustrating an exemplary symbol arrangement in the slot;

FIG. 15 is a diagram illustrating an exemplary symbol arrangement in the slot;

FIG. 16 is a configuration diagram and block diagrams of a wireless communication system according to a third embodiment;

FIG. 17 is an exemplary flowchart illustrating symbol processing by a communication apparatus according to the third embodiment of the present invention;

FIG. 18 is a diagram illustrating an exemplary symbol arrangement in a slot;

FIG. 19 is a diagram illustrating an exemplary symbol arrangement in the slot;

FIG. 20 is a diagram illustrating an exemplary symbol arrangement in the slot;

FIG. 21 is a diagram illustrating an exemplary symbol arrangement in the slot;

FIG. 22 is a diagram illustrating an exemplary symbol arrangement in the slot;

FIG. 23 is an exemplary block diagram illustrating a configuration of a communication apparatus (transmission apparatus, base station) of a conventional art which communicates by employing a coding scheme;

FIG. 24 is a diagram illustrating symbol processing by STBC;

FIG. 25 is a diagram illustrating symbol processing by SFBC; and

FIG. 26 is a diagram illustrating symbol processing by STFBC.

### REFERENCE SIGNS LIST

100 first communication apparatus (base station)
110 transmission and reception unit
120 moving state detection unit
130 determination unit
140 memory
150 control unit
152 modulation class determination unit
160 symbol processing unit
170 change processing unit
180 notification unit
200 second communication apparatus (terminal)
210 transmission and reception unit
220 control unit
300 third communication apparatus (base station)
500 communication apparatus
510 transmission and reception unit
520 control unit
530 specific processing unit
ANT, ANT 2 antenna
ANT1, ANT3 antenna group
ST1, ST2, ST10, ST20, ST30 combination of STBC
SF10, SF11, SF20 combination of SFBC
STF10 combination of STFBC
SLOT slot

### DESCRIPTION OF EMBODIMENTS

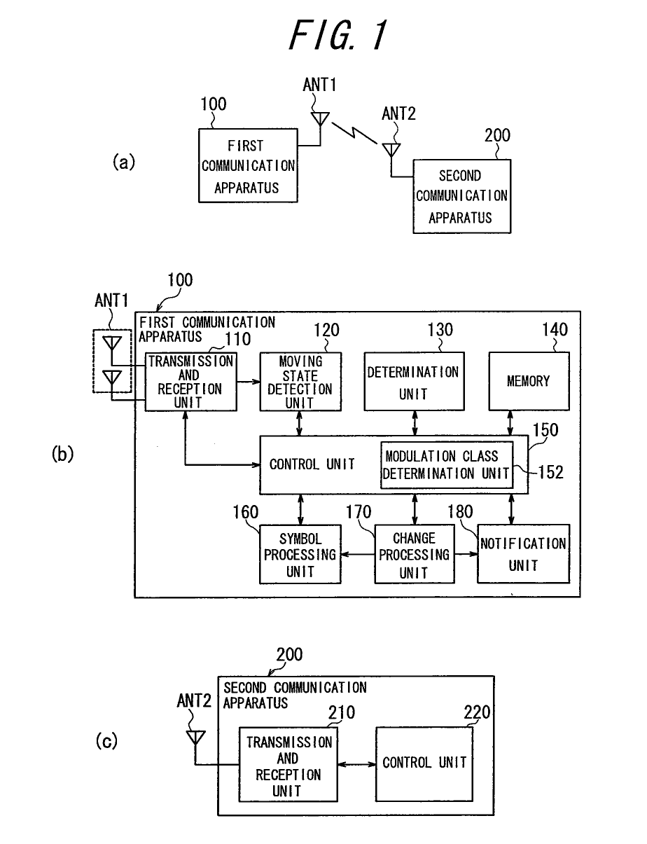

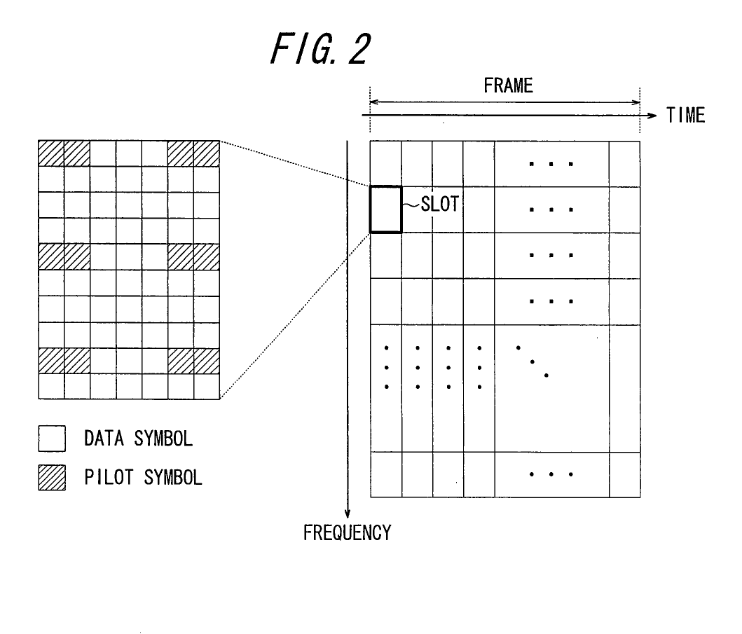

Preferred embodiments of a wireless communication apparatus according to the present invention will be described as follows, with reference to the accompanying drawings. FIG. 1(a) is a configuration diagram of a wireless communication system according to an embodiment of the present invention. As shown in the figure, the wireless communication system is constituted of a first communication apparatus (transmission station, base station) 100 functioning mainly as a transmitter, and a second communication apparatus (user terminal) 200 functioning mainly as a receiver. FIG. 1(b) is a block diagram illustrating an exemplary first communication apparatus, while FIG. 1(c) is a block diagram illustrating an exemplary second communication apparatus. As shown in FIG. 1(b), the first communication apparatus 100 is provided with a transmission and reception unit 110, a moving state detection unit 120, a determination unit 130, a memory 140, a control unit 150 for controlling the apparatus overall, a symbol processing unit 160, a change processing unit 170, a notification unit 180, and an antenna group ANT1 which includes two antennas. The control unit 150 is provided with a modulation class determination unit 152. As shown in FIG. 1(c), the second communication apparatus 200 is provided with a transmission and reception unit 210, a control unit 220 for controlling the apparatus overall, and an antenna ANT2. Wireless communication using a communication frame is performed between the first communication apparatus 100 and the second communication apparatus 200.

The moving state detection unit 120 detects a moving speed (relative speed to the base station) of the second communication apparatus 200 from a signal, which is transmitted from the second communication apparatus (terminal) 200 and received by the transmission and reception apparatus 110 via the antenna group ANT1, and outputs the moving speed as movement information to the determination unit 130. Based on the movement information being input and a modulation class (modulation scheme) of communication with the second communication apparatus 200 determined by the modulation class determination unit 152, the determination unit 130 determines whether to change a data symbol in a slot to a pilot symbol (control symbol). This is based on an idea to improve accuracy of channel estimation by increasing a probability that the second communication apparatus 200 can receive the pilot symbol. Here, it is determined to change the data symbol to the pilot symbol if the moving speed exceeds a threshold (predetermined value). The threshold has a different value in accordance with the modulation scheme of a channel and is stored as a table for each carrier frequency in the memory 140. Table 1 and Table 2 show exemplary tables of the threshold. Table 1 shows a case when a frequency is 2.5 GHz, while Table 2 shows another case when the frequency is 5 GHz. It is to be noted that the tables are mere examples, and values shown therein are thus not rigorous.

TABLE 1
When the frequency is 2.5 GHz

| Modulation | Multi-value | Threshold (Moving |
|---|---|---|
| Scheme | Number | Speed) [km/h] |
| QPSK | Small | 250 |
| 16-QAM | ↑ | 150 |
| 64-QAM | ↓ | 80 |
| 256-QAM | Large | 50 |

TABLE 2
When the frequency is 5 GHz

| Modulation | Multi-value | Threshold (Moving |
|---|---|---|
| Scheme | Number | Speed) [km/h] |
| QPSK | Small | 150 |
| 16-QAM | ↑ | 80 |
| 64-QAM | ↓ | 50 |
| 256-QAM | Large | 30 |

The tables shown above will be described here. As the modulation method has a large multi-value number, error duration to increase in the moving speed of the terminal becomes low. Therefore, as shown in Table 1, for example, when the modulation scheme is 256-QAM with a large multi-value number, the threshold (moving speed) to change the symbol to the pilot symbol is set lower than that for QPSK with a small multi-value number. In addition, since it is easily influenced by fading and the likes when the carrier frequency is higher, the threshold for 5 GHz is set lower than that for 2.5 GHz, even for the same modulation scheme.

The control unit 150 outputs control information of the data symbol to the change processing unit 170 based on a result of determination by the determination unit 130. The change processing unit 170 controls the symbol processing unit 160 based on the control information being input. It is to be noted that the control information will be described below. In addition, the modulation class determination unit 152 determines the modulation class based on quality of a received signal. Such an adaptive modulation is known in the art, and thus a detailed description thereof is omitted.

### First Embodiment

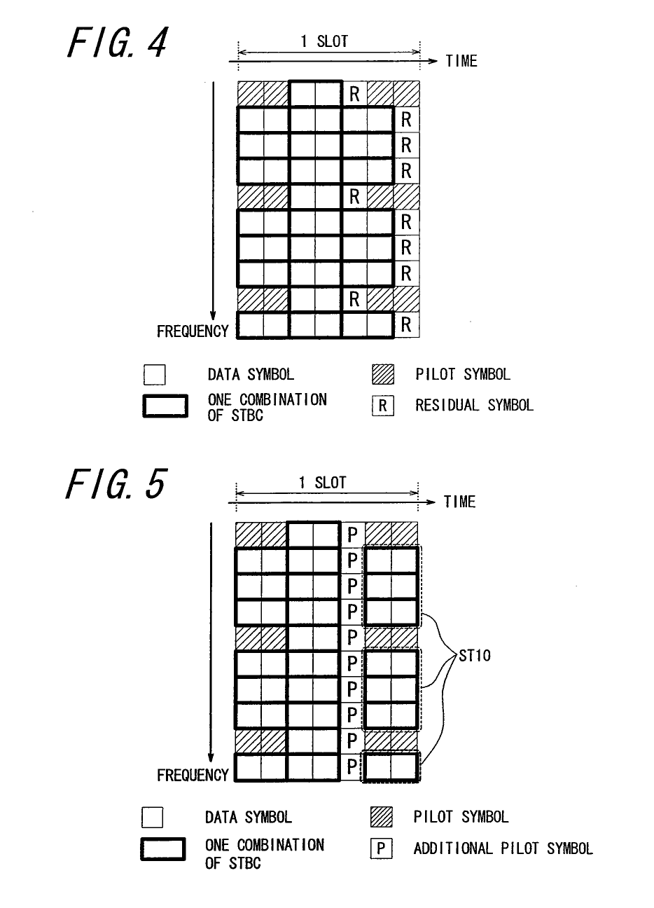

According to a first embodiment, in order to change a data symbol in a slot to a pilot symbol (control symbol), a predetermined process based on a condition of a propagation path (channel) is performed on a symbol which cannot make a combination for STBC, that is, a residual symbol when STBC is performed on data symbols in the slot. Referring to FIG. 4, for example, a combination of two symbols adjacent in a direction of a time axis surrounded by bold lines, which is made to perform STBC thereon, is defined as ‘one combination of STBC’. Thereby, symbols denoted by ‘R’ in the figure are defined as ‘residual symbols’, namely, unprocessed symbols.

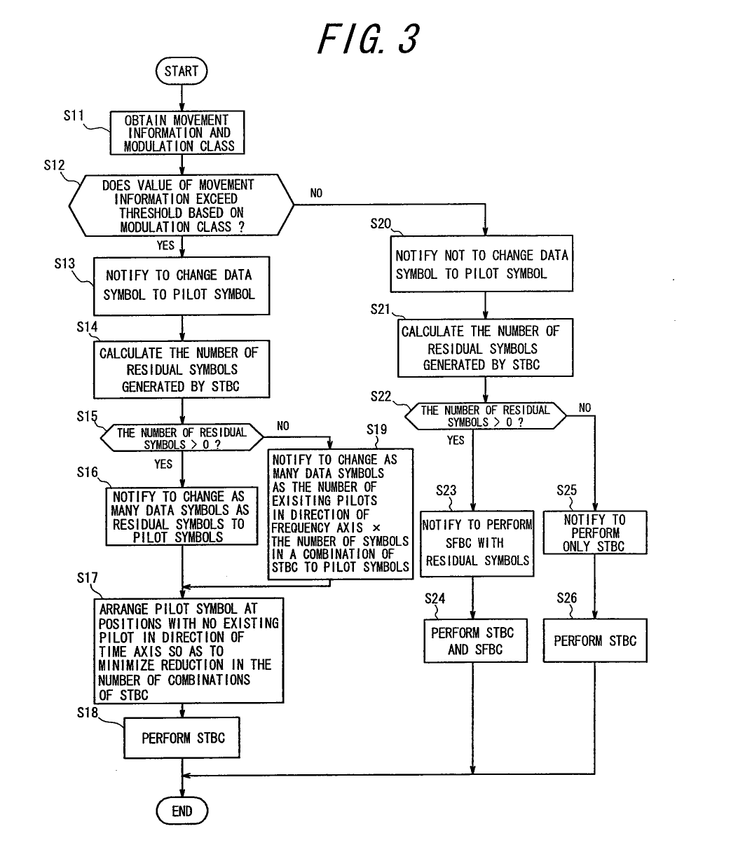

The symbol processing according to the first embodiment is described by using a flowchart and diagrams of symbol arrangements in a slot. FIG. 3 is an exemplary flowchart illustrating the symbol processing by the communication apparatus according to the first embodiment of the present invention. FIG. 4 to FIG. 9 are diagrams illustrating exemplary symbol arrangements in a slot. Although only a single slot is illustrated in the figures, similar slots are adjacent to one another in the direction of the time axis and in the direction of the frequency axis. First, at step S11, the transmission and reception unit 110 of the first communication apparatus (base station) 100 receives a signal (carrier wave) from the second communication apparatus (terminal) 200 via the antenna group ANT1, and the moving state detection unit 120 obtains (detects) movement information of the second communication apparatus 200 from the carrier wave received. The movement information may be, for example, the Doppler frequency of the carrier wave or a relative speed between the communication apparatuses (a moving speed of the second communication apparatus 200 if the first communication apparatus 100 is not moving). In addition, the modulation class determination unit 152 outputs a modulation class for each carrier wave in the communication with the second communication apparatus 200 to the determination unit 130. At step S12, the determination unit 130 determines whether a value of the movement information detected by the moving state detection unit 120 exceeds a threshold, which is determined based on the modulation class input from the modulation class determination unit 152. The threshold is stored in the memory 140 in advance as a table in which a boundary value (the Doppler frequency and/or a value of the relative speed) degrading accuracy of channel estimation is defined to a carrier frequency, such as Table 1 and Table 2 shown above. That is, if the value of the movement information exceeds the threshold, it indicates that the terminal 200 is moving at a high speed and that may reduce accuracy of channel estimation. Accordingly, if it is determined that the value of the movement information exceeds the threshold at step S12, the symbol processing proceeds to step S13, where the change processing unit 170 notifies the symbol processing unit 160 to change the data symbol to the pilot symbol (control information).

Next, at step S14, the change processing unit 170 calculates the number of residual symbols to be generated by performing STBC on the data in the frame. At step S15, the determination unit 130 determines whether there is a residual symbol. If there is a residual symbol, the symbol processing proceeds to step S16, where the change processing unit 170 notifies the symbol processing unit 160 that as many data symbols as the residual symbols are changed to pilot symbols (control information). Next, the symbol processing proceeds to step S17, where the symbol processing unit 160 arranges pilot symbols at positions with no existing pilot in the direction of the time axis. Because of the purpose of the pilot symbol, it is preferred that a period in which the pilot symbols are not transmitted is not long. Accordingly, at step S17, the symbol processing unit 160 arranges the pilot symbols at positions substantially equally dividing the period in which the pilot symbols are not transmitted. At this time, the pilot symbols are arranged such as to minimize the number of combinations of STBC reduced because of the arrangement.

Changes of the symbol arrangement when step S13 to S17 are performed are described by using FIG. 4 and FIG. 5. It is assumed that, when STBC is performed on the slot at step S14, ten residual symbols ‘R’ are generated as shown in FIG. 4. Accordingly, ten additional pilot symbols are arranged at step S17. At this time, the additional pilot symbols are arranged at positions which have no existing pilot symbols in the direction of the time axis, substantially equally divide the period in which the pilot symbols are not transmitted, and also minimize reduction of the number of combinations of STBC (there are 24 combinations in the example of FIG. 4.) even if the number is reduced because of addition of the pilot symbols. That is, while enhancing accuracy of channel estimation by increasing the number of times to transmit the pilot symbols, reduction of data to be transmitted is minimized, thereby maintaining throughput before the symbol processing (before the pilot symbols are added). Accordingly, in the example of FIG. 4, ten pilot symbols are added to symbol positions at 5th row from the left in the direction of the time axis, which equally divide the period in which the pilot symbols are not transmitted, and are close to symbol positions at 4^{th} row from the left in the direction of the time axis, as well as not reducing the number of combinations of STBC (see FIG. 5). In addition, combinations of STBC ST10 are newly created as shown in FIG. 5. It is also possible to add the pilot symbols to symbol positions at 3rd row from the left in the direction of the time axis, as it enables to obtain the same effect as adding the pilot symbols to the symbol positions at the 5th row from the left.

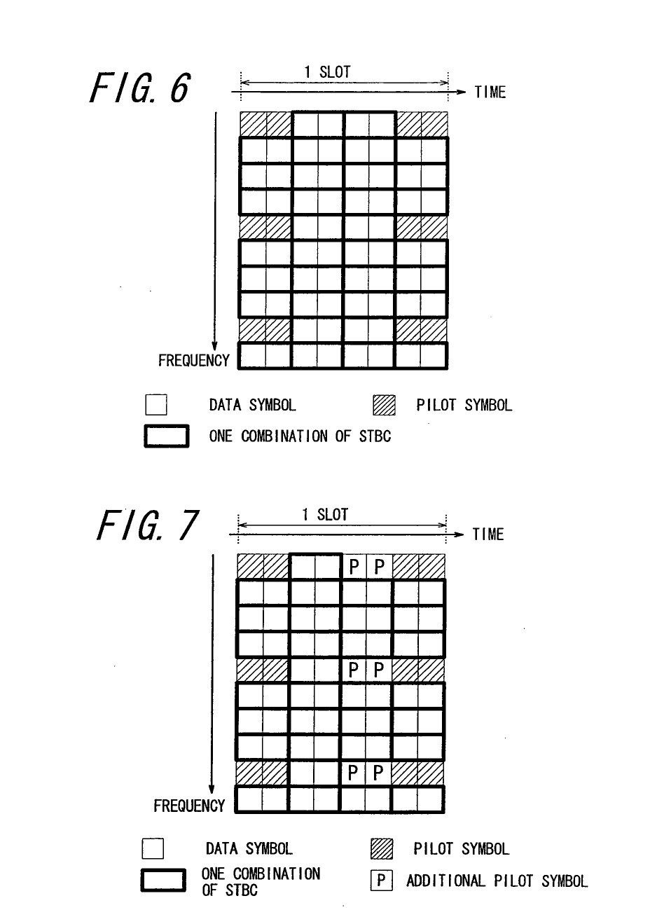

Now, back to a description of the flowchart in FIG. 3. If it is determined that there is no residual symbols at step S15, the symbol processing proceeds to step S19, where the change processing unit 170 notifies the symbol processing unit 160 that a predetermined number of data symbols are changed to the pilot symbols (control information). The predetermined number is a result of multiplying the number of existing pilots arranged in the direction of the frequency axis by the number of symbols in one combination of STBC (the number of symbols combined to perform STBC). Next, changes of the symbol arrangement when step S13 to S15, S19 and S17 are performed are described by using FIG. 6 and FIG. 7. Here, it is assumed that no residual symbols are generated as shown in FIG. 6 when STBC is performed on the slot at step S14. Accordingly, the symbol processing proceeds to step S19 to set the predetermined number of the pilot symbols which should be added. In an example of FIG. 6, the predetermined number is: the number of existing pilots arranged in the direction of the frequency axis (3)×the number of symbols in one combination of STBC (2)=6. Thereby, six additional pilot symbols are arranged at step S17. Positions to add the pilot symbols at step S17 are determined by the same process described above and thus description thereof is omitted here. In the example shown in FIG. 6, six additional pilot symbols ‘P’ are arranged as shown in FIG. 7.

Once again, back to the description of the flowchart shown in FIG. 3, to describe a case where it is determined at step S12 that the value of the movement information does not exceed the threshold. When it is determined at step S12 that the value of the movement information does not exceed the threshold, the symbol processing proceeds to step S20, where the change processing unit 170 notifies the symbol processing unit 160 that the data symbol is not changed to the pilot symbol (control information). Next, at step S21, the change processing unit 170 calculates the number of residual symbols to be generated by performing STBC on the data in the frame. At step S22, the determination unit 130 determines whether there is a residual symbol. If it is determined that there is a residual symbol, the symbol processing proceeds to step S23, where the change processing unit 170 notifies the symbol processing unit 160 that SFBC is performed on the residual symbols (control information). At step S24, the symbol processing unit 160 performs STBC and SFBC based on notification (control information) from the change processing unit 170. If it is determined at step S22 that there is no residual symbol, the change processing unit 170 notifies the symbol processing unit 160 that only STBC is performed (control information) at step S25. At step S26, the symbol processing unit 160 performs STBC based on the notification (control information) from the change processing unit 170.

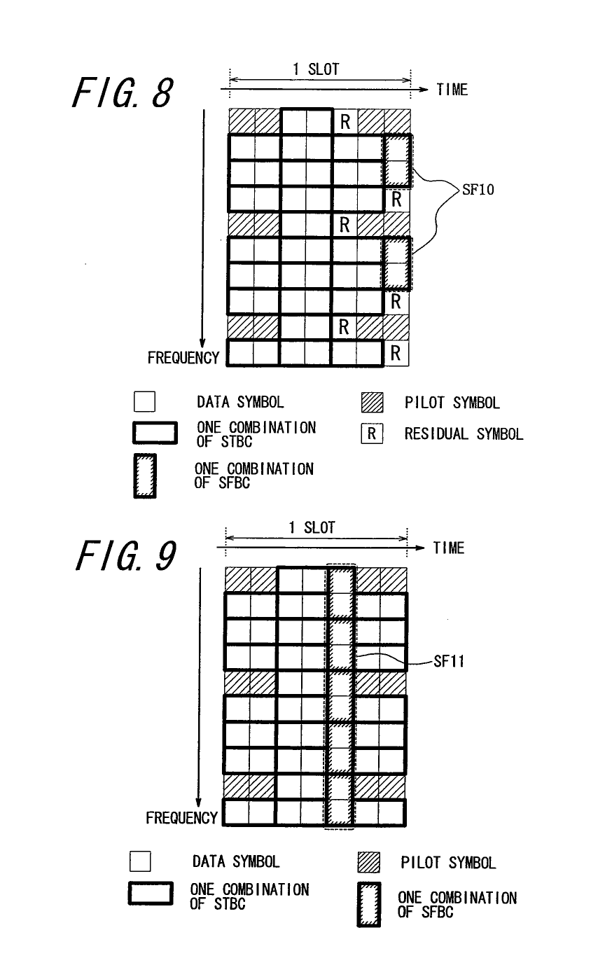

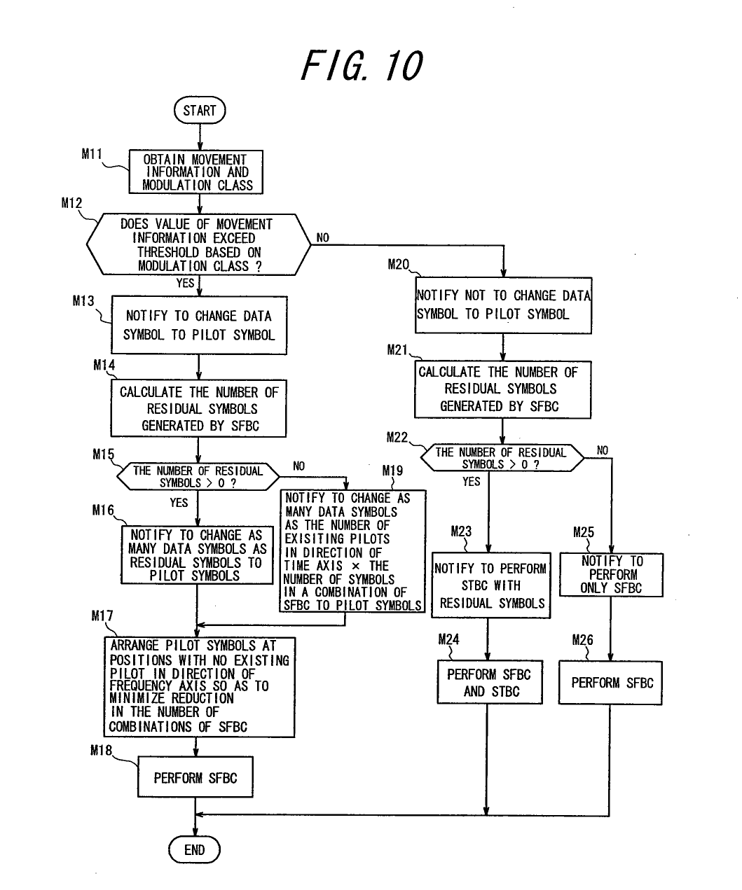

Changes of the symbol arrangement when steps S20 to S26 are performed are described by using FIG. 4, FIG. 8 and FIG. 9. It is assumed that, when STBC is performed on the slot at step S21, ten residual symbols ‘R’ are generated as shown in FIG. 4. Accordingly, it is informed that SFBC is performed on the residual symbols, at step S23. This intends to improve throughput than that before the symbol processing (processing to perform SFBC on the residual symbols) by transmitting symbols, which become residual by STBC, by using SFBC. Based on notification (control information) from the change processing unit 170, the symbol processing unit 160 creates combinations of SFBC with the residual symbols. It is possible to create combinations of SFBC SF10 as shown in FIG. 8, for example. In order to improve throughput by effectively utilizing the residual symbols even more, it is also possible to create combinations of SFBC SF11 as shown in FIG. 9.

When the symbol processing shown in the flowchart in FIG. 3 ends, the control unit 150 outputs a transmission signal created by the symbol processing unit 160 to the transmission and reception unit 110, and the transmission and reception unit 110 transmits the transmission signal via the antenna group ANT1. Although the first communication apparatus (base station) 100 is provided with two antennas as shown in FIG. 1, the present invention is not limited to it. The number of antennas may be other than two, as it is possible to transmit via any number of antennas by weighting two-path transmission signals.

In addition, each notification control by the change processing unit 170 based on a result of determination by the determination unit 130 (steps S12, S15 and S22) may be executed immediately after the determination or when a predetermined time has passed after the determination. If the notification control is performed immediately after the determination, notification information (information to change the data symbol to the pilot symbol or information to change as many data symbols as residual symbols to pilot symbols) may be notified in a control information region called MAP defined in WiMAX standard, for example. If the notification control is performed when the predetermined time has passed, the notification information is transmitted as data to the second communication apparatus (terminal) 200, and then the process to change the symbols stated above may be performed from a following communication frame.

### Second Embodiment

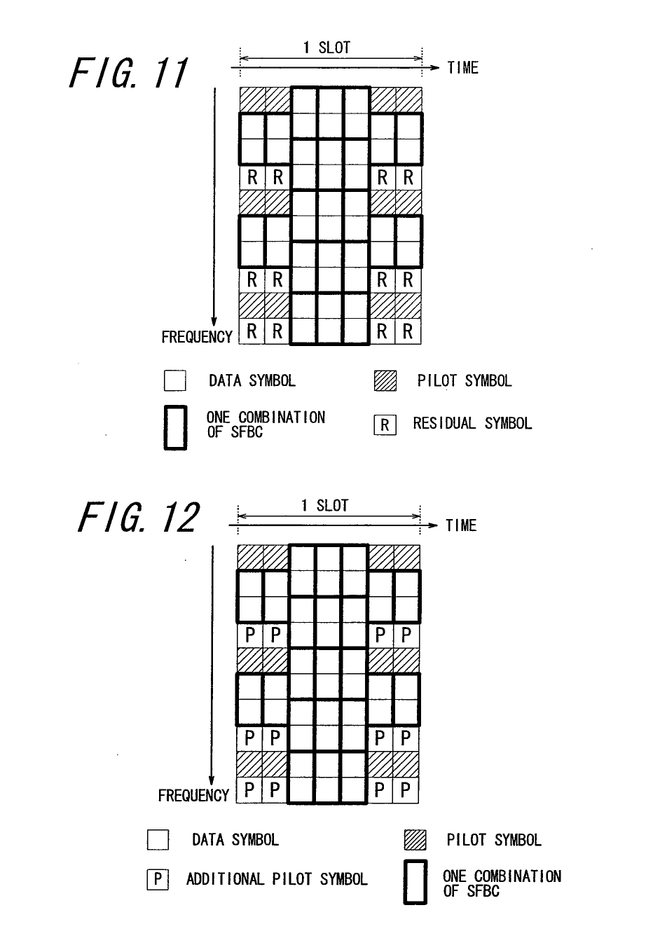

According to a second embodiment, in order to change a data symbol in a slot to a pilot symbol (control symbol), a predetermined process based on a condition of a propagation path (channel) is performed on a symbol (residual symbol) which cannot make a combination for SFBC when SFBC is performed on data symbols in the slot. As shown in FIG. 11, for example, a combination of two symbols adjacent in a direction of a frequency axis surrounded by bold lines, which is made to perform SFBC thereon, is defined as ‘one combination of SFBC’. Thereby, symbols denoted by ‘R’ in the figure are defined as ‘residual symbols’, namely, unprocessed symbols.

The symbol processing according to the second embodiment is described by using a flowchart and diagrams of symbol arrangements in a slot. FIG. 10 is an exemplary flowchart illustrating symbol processing by the communication apparatus according to the second embodiment of the present invention. FIG. 11 to FIG. 15 are diagrams illustrating exemplary symbol arrangements in a slot. Although only a single slot is illustrated in the figures, similar slots are adjacent to one another in the direction of the time axis and in the direction of the frequency axis. First, at step M11, the transmission and reception unit 110 of the first communication apparatus (base station) 100 receives a signal (carrier wave) from the second communication apparatus (terminal) 200 via the antenna group ANT1, and the moving state detection unit 120 obtains (detects) movement information of the second communication apparatus 200 from the carrier wave received. The movement information may be, for example, the Doppler frequency of the carrier wave or a relative speed between the communication apparatuses (a moving speed of the second communication apparatus 200 if the first communication apparatus 100 is not moving). In addition, the modulation class determination unit 152 outputs a modulation class for each carrier wave in the communication with the second communication apparatus 200 to the determination unit 130. At step M12, the determination unit 130 determines whether a value of the movement information detected by the moving state detection unit 120 exceeds a threshold, which is determined based on the modulation class input from the modulation class determination unit 152. The threshold is stored in the memory 140 in advance as a table in which a boundary value (the Doppler frequency and/or a value of the relative speed) degrading accuracy of channel estimation is defined to a carrier frequency, such as Table 1 and Table 2 shown above. That is, if the value of the movement information exceeds the threshold, it indicates that the terminal 200 is moving at a high speed and that may reduce accuracy of channel estimation. Accordingly, if it is determined that the value of the movement information exceeds the threshold at step M12, the symbol processing proceeds to step M13, where the change processing unit 170 notifies the symbol processing unit 160 to change the data symbol to the pilot symbol (control information).

Next, at step M14, the change processing unit 170 calculates the number of residual symbols to be generated by performing SFBC on the data in the frame. At step M15, the determination unit 130 determines whether there is a residual symbol. If there is a residual symbol, the symbol processing proceeds to step M16, where the change processing unit 170 notifies the symbol processing unit 160 that as many data symbols as the residual symbols are changed to pilot symbols (control information). Next, the symbol processing proceeds to step M17, where the symbol processing unit 160 arranges the pilot symbols at positions with no existing pilots in the direction of the frequency axis. Because of the purpose of the pilot symbol, it is preferred to have few frequencies at which pilot symbols are not transmitted. Accordingly, at step M17, the symbol processing unit 160 arranges the pilot symbols at positions substantially equally dividing the frequency band in which the pilot symbols are not transmitted. At this time, the pilot symbols are arranged such as to minimize the number of combinations of SFBC reduced because of the arrangement.

Changes of the symbol arrangement when step M13 to M17 are performed are described by using FIG. 11 and FIG. 12. It is assumed that, when SFBC is performed on the slot at step M14, 12 residual symbols a′ are generated as shown in FIG. 11. Accordingly, 12 additional pilot symbols are arranged at step M17. At this time, the additional pilot symbols are arranged at positions, which have no existing pilot symbols in the direction of the frequency axis, substantially equally divide a frequency band in which the pilot symbols are not transmitted, and also minimize reduction of the number of combinations of SFBC (there are 23 combinations in the example of FIG. 11.) even if the number is reduced because of addition of the pilot symbols. That is, while enhancing accuracy of channel estimation by increasing the frequency to transmit the pilot symbol, reduction of data to be transmitted is minimized, thereby maintaining throughput before the symbol processing (before the pilot symbols are added). Accordingly, in the example of FIG. 11, four pilot symbols are added to symbol positions at 4th and 8th rows from the top in the direction of the frequency axis, which equally divide the frequency band in which the pilot symbols are not transmitted, and are close to symbol positions at 3rd and 7th rows from the top in the direction of the frequency axis, as well as not reducing the number of combinations of SFBC (see FIG. 11). In addition, the residual symbols at 10th row from the top in the direction of the frequency axis are changed to pilot symbols as well. It is also possible to obtain the same effect by adding the pilot symbols to the symbol positions at 2nd and 6th rows from the top in the direction of the frequency axis.

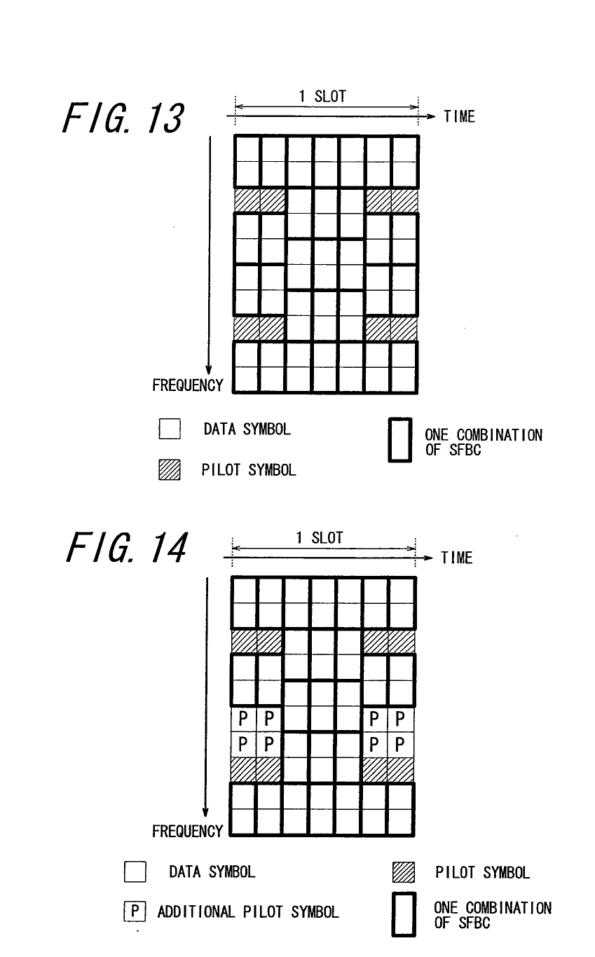

Now, back to a description of the flowchart in FIG. 10. If it is determined that there is no residual symbols at step M15, the symbol processing proceeds to step M19, where the change processing unit 170 notifies the symbol processing unit 160 that a predetermined number of data symbols are changed to the pilot symbols (control information). The predetermined number is a result of multiplying the number of existing pilots arranged in the direction of the time axis by the number of symbols in one combination of SFBC (the number of symbols combined to perform SFBC). Next, changes of the symbol arrangement when step M13 to M15, M19 and M17 are performed are described by using FIG. 13 and FIG. 14. Here, it is assumed that no residual symbols are generated as shown in FIG. 13 when SFBC is performed on the slot at step M14. Accordingly, the symbol processing proceeds to step M19 to set the predetermined number of the pilot symbols which should be added. In an example of FIG. 13, the predetermined number is: the number of existing pilots arranged in the direction of the time axis (4)×the number of symbols in one combination of SFBC (2)=8. Thereby, eight additional pilot symbols are arranged at step M17. Positions to add the pilot symbols at step M17 are determined by the same process stated above and thus description thereof is omitted here. In the example of FIG. 13, eight additional pilot symbols ‘P’ are arranged as shown in FIG. 14.

Once again, back to the description of the flowchart shown in FIG. 10, to describe a case where it is determined at step M12 that the value of the movement information does not exceed the threshold. When it is determined at step M12 that the value of the movement information does not exceed the threshold, the symbol processing proceeds to step M20, where the change processing unit 170 notifies the symbol processing unit 160 that the data symbol is not changed to the pilot symbol (control information). Next, at step M21, the change processing unit 170 calculates the number of residual symbols to be generated by performing SFBC on the data in the frame. At step M22, the determination unit 130 determines whether there is a residual symbol. If it is determined that there is a residual symbol, the symbol processing proceeds to step M23, where the change processing unit 170 notifies the symbol processing unit 160 that STBC is performed with the residual symbols (control information). At step M24, the symbol processing unit 160 performs SFBC and STBC based on notification (control information) from the change processing unit 170. If it is determined at step M22 that there is no residual symbol, the change processing unit 170 notifies the symbol processing unit 160 that only SFBC is performed (control information) at step M25. At step M26, the symbol processing unit 160 performs SFBC based on the notification (control information) from the change processing unit 170.

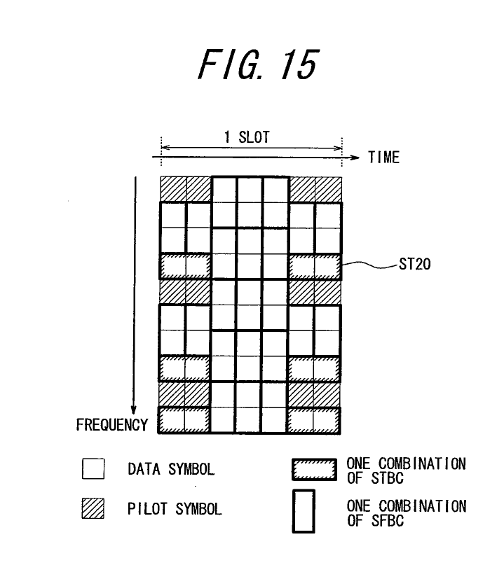

Changes of the symbol arrangement when steps M20 to M26 are performed are described by using FIG. 11 and FIG. 15. It is assumed that, when SFBC is performed on the slot at step M21, 12 residual symbols ‘R’ are generated as shown in FIG. 11. Accordingly, it is notified that STBC is performed with the residual symbols, at step M23. This intends to improve throughput than that before the symbol processing (processing to perform STBC on the residual symbols) by transmitting symbols, which become residual by SFBC, by using STBC. Based on notification (control information) from the change processing unit 170, the symbol processing unit 160 creates combinations of STBC with the residual symbols. It is possible to create combinations of STBC ST20 as shown in FIG. 15 (only a single combination of STBC is provided with a reference sign in the figure), for example.

When the symbol processing shown in the flowchart in FIG. 10 ends, the control unit 150 outputs a transmission signal created by the symbol processing unit 160 to the transmission and reception unit 110, and the transmission and reception unit 110 transmits the transmission signal via the antenna group ANT1. Although the first communication apparatus (base station) 100 is provided with two antennas as shown in FIG. 1, the present invention is not limited to it. The number of antennas may be other than two, as it is possible to transmit via any number of antennas by weighting two-path transmission signals.

In addition, each notification control by the change processing unit 170 based on a result of determination by the determination unit 130 (steps M12, M15 and M22) may be executed immediately after the determination or when a predetermined time has passed after the determination. If the notification control is performed immediately after the determination, notification information (information to change the data symbol to the pilot symbol or information to change as many data symbols as residual symbols to pilot symbols) may be notified in a control information region called MAP defined in WiMAX standard, for example. If the notification control is performed when the predetermined time has passed, the notification information is transmitted as data to the second communication apparatus (terminal) 200, and then the process to change the symbols described above may be performed from a following communication frame.

### Third Embodiment

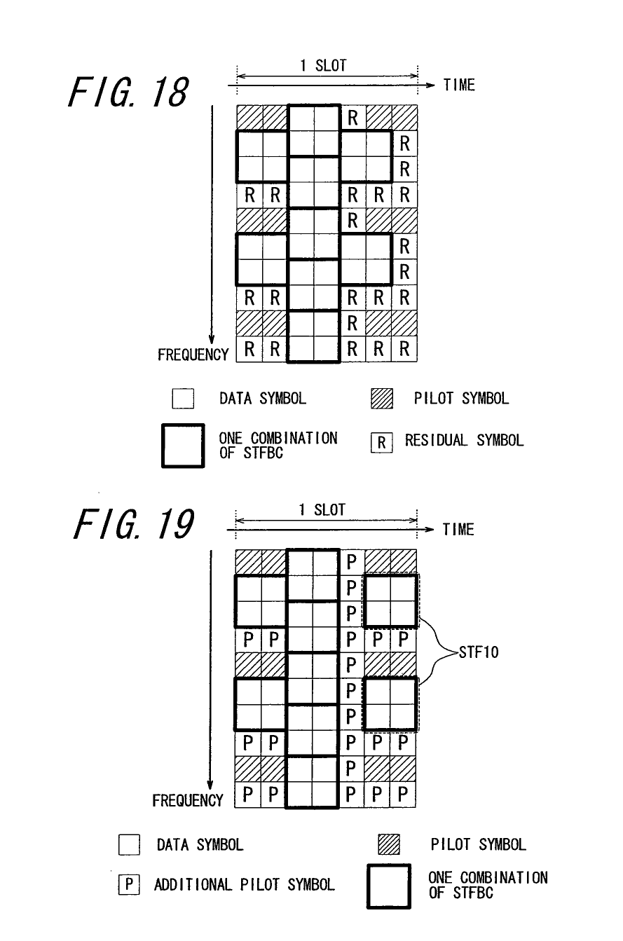

According to a third embodiment, in order to change a data symbol in a slot to a pilot symbol (control symbol), a predetermined process based on a condition of a propagation path (channel) is performed on a symbol which cannot make a combination for STFBC, that is, a residual symbol when STFBC is performed on data symbols in the slot. As shown in FIG. 18, for example, a combination of two symbols adjacent in a direction of a time axis and also in a direction of a frequency axis surrounded by bold lines, which is made to perform STFBC thereon, is defined as ‘one combination of STFBC’. Thereby, symbols denoted by a′ in the figure are defined as ‘residual symbols’, namely, unprocessed symbols.

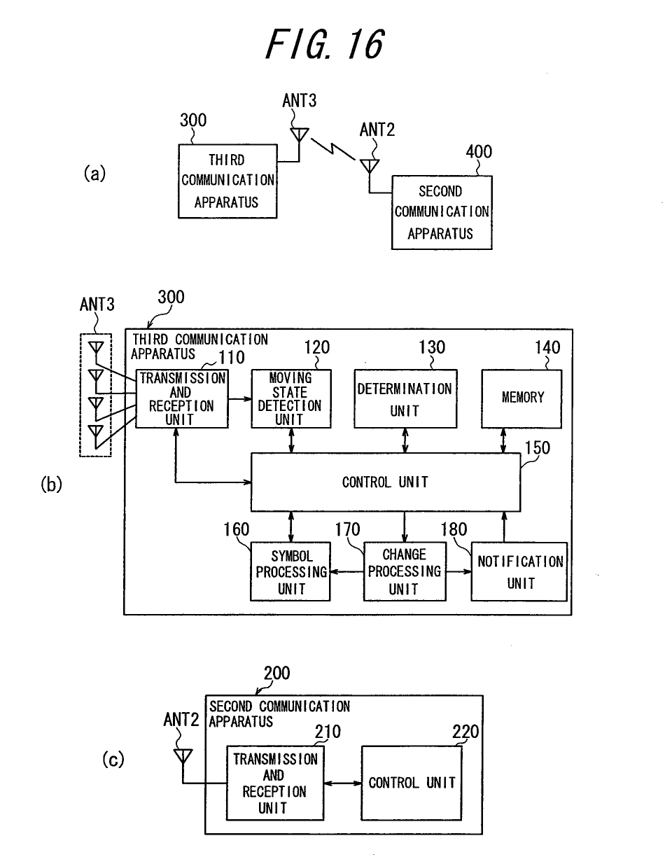

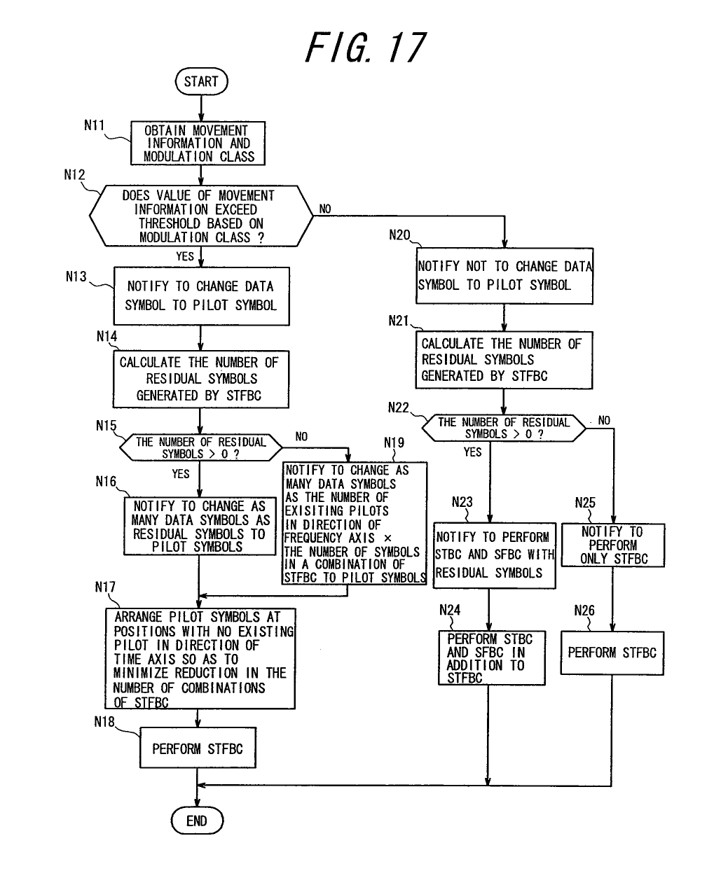

FIG. 16 shows exemplary configuration and block diagrams of a wireless communication system according to the third embodiment. The wireless communication system is constituted of a third communication apparatus (transmission station, base station) 300 mainly functioning as a transmitter and a second communication apparatus (user terminal) 200 mainly functioning as a receiver. FIG. 16(b) is a block diagram illustrating an exemplary third communication apparatus, while FIG. 16(c) is a block diagram illustrating an exemplary second communication apparatus. Here, units identical to those of the first communication apparatus 100 shown in FIG. 1(b) are provided with the same reference signs and descriptions thereof are omitted. The third communication apparatus 300 is provided with an antenna group ANT3 constituted of 4 antennas.

The symbol processing according to the third embodiment is described by using a flowchart and diagrams of symbol arrangements in a slot. FIG. 17 is an exemplary flowchart illustrating the symbol processing by the communication apparatus according to the third embodiment of the present invention. FIG. 18 to FIG. 22 are diagrams illustrating exemplary symbol arrangements in a slot. Although only a single slot is illustrated in the figures, similar slots are adjacent to one another in the direction of the time axis and in the direction of the frequency axis. First, at step N11, the transmission and reception unit 110 of the third communication apparatus (base station) 300 receives a signal (carrier wave) from the second communication apparatus (terminal) 200 via the antenna group ANT3, and the moving state detection unit 120 obtains (detects) movement information of the second communication apparatus 200 from the carrier wave received. The movement information may be, for example, the Doppler frequency of the carrier wave or a relative speed between the communication apparatuses (a moving speed of the second communication apparatus 200 if the first communication apparatus 100 is not moving). In addition, the modulation class determination unit 152 outputs a modulation class for each carrier wave of the communication with the second communication apparatus 200, to the determination unit 130. At step N12, the determination unit 130 determines whether a value of the movement information detected by the moving state detection unit 120 exceeds a threshold, which is determined based on the modulation class input from the modulation class determination unit 152. The threshold is stored in the memory 140 in advance as a table in which a boundary value (the Doppler frequency and/or a value of the relative speed) degrading accuracy of channel estimation is defined to a carrier frequency, such as Table 1 and Table 2 shown above. That is, if the value of the movement information exceeds the threshold, it indicates that the terminal 200 is moving at a high speed and that may reduce accuracy of channel estimation. Accordingly, if it is determined that the value of the movement information exceeds the threshold at step N12, the symbol processing proceeds to step N13, where the change processing unit 170 notifies the symbol processing unit 160 to change the data symbol to the pilot symbol (control information).

Next, at step N14, the change processing unit 170 calculates the number of residual symbols to be generated by performing STFBC on the data in the frame. At step N15, the determination unit 130 determines whether there is a residual symbol. If there is a residual symbol, the symbol processing proceeds to step N16, where the change processing unit 170 notifies the symbol processing unit 160 that as many data symbols as the residual symbols are changed to pilot symbols (control information). Next, the symbol processing proceeds to step N17, where the symbol processing unit 160 arranges pilot symbols at positions with no existing pilot arranged in the direction of the time axis. Because of the purpose of the pilot symbol, it is preferred that a period in which the pilot symbols are not transmitted is not long. Accordingly, at step N17, the symbol processing unit 160 arranges the pilot symbols at positions substantially equally dividing the period in which the pilot symbols are not transmitted. At this time, the pilot symbols are arranged such as to minimize the number of combinations of STFBC reduced because of the arrangement.

Changes of the symbol arrangement when step N13 to N17 are performed are described by using FIG. 18 and FIG. 19. It is assumed that, when STFBC is performed on the slot at step N14, 22 residual symbols ‘R’s are generated as shown in FIG. 18. Accordingly, 22 additional pilot symbols are arranged at step N17. At this time, the additional pilot symbols are arranged at positions, which have no existing pilot symbols in the direction of the time axis, substantially equally divide the period in which the pilot symbols are not transmitted, and also minimize reduction of the number of combinations of STFBC (there are 9 combinations in the example of FIG. 18.) even if the number is reduced because of addition of the pilot symbols. That is, while enhancing accuracy of channel estimation by increasing the number of times to transmit the pilot symbol, reduction of data to be transmitted is minimized, thereby maintaining throughput before the symbol processing (before the pilot symbols are added). Accordingly, in the example of FIG. 18, ten pilot symbols are added to symbol positions at 5th row from the left in the direction of the time axis, which equally divide the period in which the pilot symbols are not transmitted, and are close to symbol positions at 4^{th} row from the left in the direction of the time axis, as well as not reducing the number of combinations of STFBC (see FIG. 19). In addition, combinations of STBC STF10 are newly created as shown in FIG. 19, and other residual symbols are changed to pilot symbols. It is also possible to add the pilot symbol to a symbol position at 3rd row from the left in the direction of the time axis, as it enables to obtain the same effect as adding the pilot symbols to the symbol positions at the 5th row from the left.

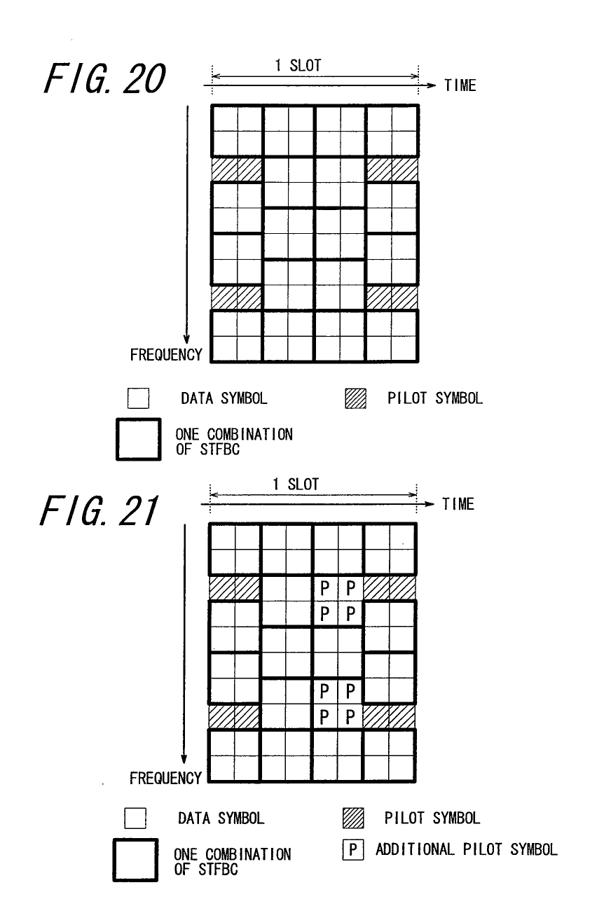

Now, back to a description of the flowchart in FIG. 17. If it is determined that there is no residual symbols at step N15, the symbol processing proceeds to step N19, where the change processing unit 170 notifies the symbol processing unit 160 that a predetermined number of data symbols are changed to pilot symbols (control information). The predetermined number is a result of multiplying the number of existing pilots in the direction of the frequency axis by the number of symbols in one combination of STFBC (the number of symbols combined to perform STFBC). Next, changes of the symbol arrangement when step N13 to N15, N19 and N17 are performed are described by using FIG. 20 and FIG. 21. Here, it is assumed that no residual symbols are generated as shown in FIG. 20 when STFBC is performed on the slot at step N14. Accordingly, the symbol processing proceeds to step N19 to set the predetermined number of the pilot symbols which should be added. In an example shown in FIG. 20, the predetermined number is: the number of existing pilots arranged in the direction of the frequency axis (2)×the number of symbols in one combination of STFBC (4)=8. Thereby, eight additional pilot symbols are arranged at step N17. Positions to add the pilot symbols at step N17 are determined by the same process described above and thus description thereof is omitted here. In the example of FIG. 20, eight additional pilot symbols ‘P’ are arranged as shown in FIG. 21.

Once again, back to the description of the flowchart shown in FIG. 17, to describe a case where it is determined at step N12 that the value of the movement information does not exceed the threshold. When it is determined at step N12 that the value of the movement information does not exceed the threshold, the symbol processing proceeds to step N20, where the change processing unit 170 notifies the symbol processing unit 160 that the data symbol is not changed to the pilot symbol (control information). Next, at step N21, the change processing unit 170 calculates the number of residual symbols to be generated by performing STFBC on the data in the frame. At step N22, the determination unit 130 determines whether there is a residual symbol. If it is determined that there is a residual symbol, the symbol processing proceeds to step N23, where the change processing unit 170 notifies the symbol processing unit 160 that STBC and/or SFBC is performed with the residual symbols (control information). At step N24, the symbol processing unit 160 performs STFBC, STBC and/or SFBC based on notification (control information) from the change processing unit 170. If it is determined at step N22 that there is no residual symbol, the change processing unit 170 notifies the symbol processing unit 160 that only STFBC is performed (control information) at step N25. At step N26, the symbol processing unit 160 performs STFBC based on the notification (control information) from the change processing unit 170.

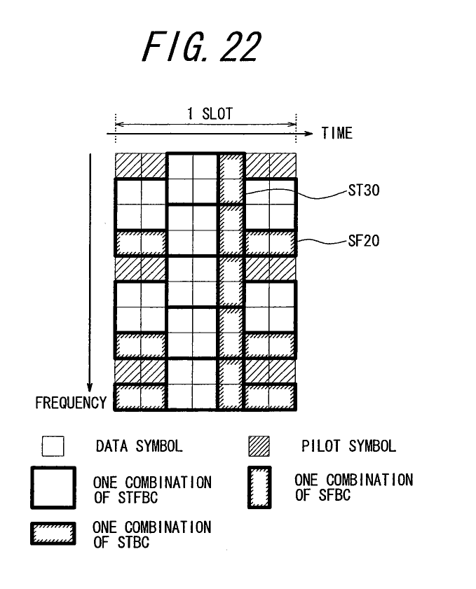

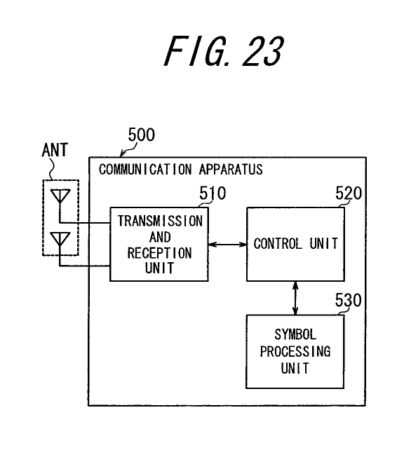

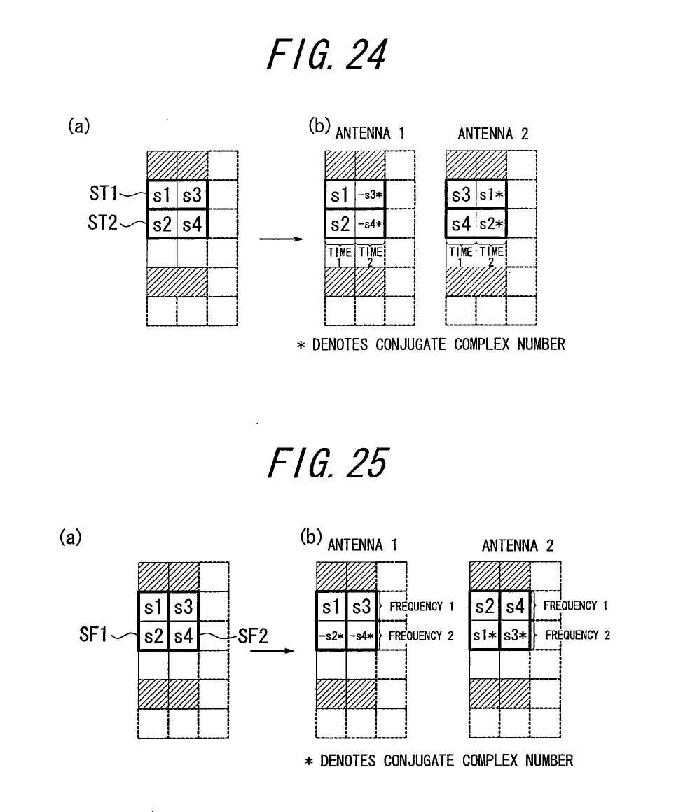

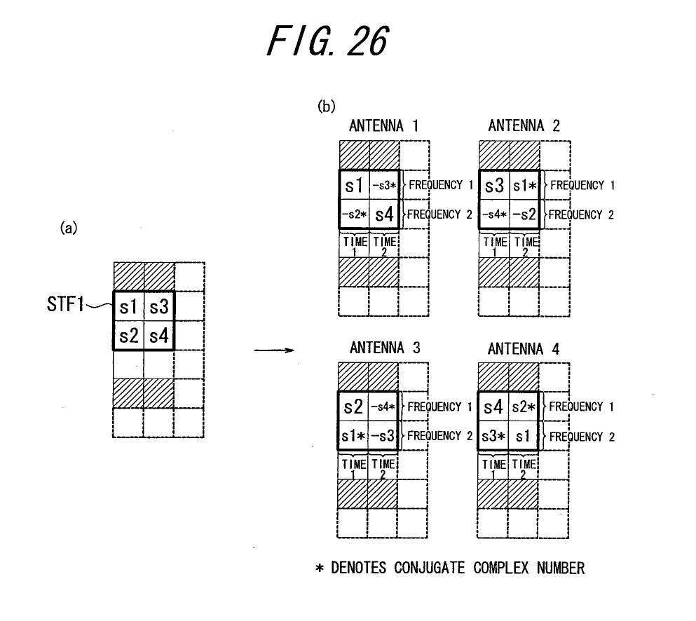

Changes of the symbol arrangement when steps N20 to N26 are performed are described by using FIG. 18 and FIG. 19. It is assumed that, when STFBC is performed on the slot at step N21, 22 residual symbols ‘R’ are generated as shown in FIG. 18. Accordingly, it is informed that STBC or SFBC is performed with the residual symbols, at step N23. This intends to improve throughput than that before the symbol processing (processing to perform STBC and/or SFBC on the residual symbols) by transmitting symbols, which become residual by STFBC, by using STBC and/or SFBC. Based on notification (control information) from the change processing unit 170, the symbol processing unit 160 creates combinations of STBC or SFBC with the residual symbols. It is possible to create combinations of STBC ST30, and combinations of SFBC SF20 as shown in FIG. 22, for example. (It is to be noted that only a respective single combination is provided with a reference sign in the figure.)

When the symbol processing shown in the flowchart in FIG. 17 ends, the control unit 150 outputs a transmission signal created by the symbol processing unit 160 to the transmission and reception unit 110, and the transmission and reception unit 110 transmits the transmission signal via the antenna group ANT3. Although the third communication apparatus (base station) 300 is provided with four antennas as shown in FIG. 16, the present invention is not limited to it. The number of antennas may be other than four, as it is possible to transmit via any number of antennas by weighting four-path transmission signals.

In addition, each notification control by the change processing unit 170 based on a result of the determination unit 130 (steps N12, N15 and N22) may be executed immediately after the determination or when a predetermined time has passed after the determination. If the notification control is performed immediately after the determination, notification information (information to change the data symbol to the pilot symbol or information to change as many data symbols as the residual symbols to pilot symbols) may be notified in a control information region called MAP defined in WiMAX standard. If the notification control is performed when the predetermined time has passed, the notification information is transmitted as data to the second communication apparatus (terminal) 200, and then the process to change the symbols stated above may be performed from a following communication frame.

An advantage of the symbol processing according to the present invention is described here once again. According to the present invention, when transmitting the data symbol to another communication apparatus by employing a coding scheme such as STBC (Space Time Block Coding) scheme or SFBC (Space Frequency Block Coding) scheme and the adaptive modulation scheme, a condition of the propagation path is determined in accordance with the modulation scheme. The pilot symbols are added if there is a possibility that accuracy of channel estimation is reduced because of poor conditions of the propagation path, and thereby accuracy of channel estimation is maintained. Moreover, there is another advantage that throughput is improved, as the residual symbols are utilized efficiently.

Although the present invention has been described with reference to exemplary drawings and embodiments, it will be understood by those skilled in the art that many variation or modifications may be implemented easily based on the disclosure of the present invention. Accordingly, all such variation and modification are intended to be included within the scope of the present invention. For example, a function in each method and in each step may be rearranged avoiding logical inconsistency. And, a plurality of units and steps and the like can be combined or divided. In addition, for example, values in Table 1 and Table 2 are mere examples and thus the present invention is not limited to them. The values in the table may be determined in advance at the transmission side or varied (updated) suitably in accordance with the propagation path.

1. A communication apparatus for performing communication with another communication apparatus by using a communication frame including a plurality of slots, each slot having a plurality of symbols, and employing an adaptive modulation scheme, comprising:
a processing unit for performing symbol processing for each slot;
a detection unit for detecting a value indicating a changing state of a propagation path between the another communication apparatus and the communication apparatus;
a change processing unit for controlling the processing unit to change the symbol to a control symbol, based on the value indicating the changing state detected by the detection unit and a modulation scheme in the communication between the another communication apparatus and the communication apparatus; and
a transmission unit for transmitting a communication frame including a slot after control by the change processing unit to the another communication apparatus.

2. The communication apparatus according to claim 1, wherein the change processing unit controls the processing unit to change the symbol to the control symbol if the value indicating the changing state exceeds a predetermined value based on the modulation scheme in the communication between the another communication apparatus and the communication apparatus.

3. The communication apparatus according to claim 1, wherein the value indicating the changing state is a relative speed between the another communication apparatus and the communication apparatus or a Doppler frequency.

4. The communication apparatus according to claim 1, wherein the change processing unit controls the processing unit, if there is an unprocessed symbol in a single slot when the symbol processing is performed on the single slot by the processing unit, so as to change the unprocessed symbol to the control symbol.

5. A communication method of a communication apparatus for performing communication with another communication apparatus by using a communication frame including a plurality of slots, each slot having a plurality of symbols, and employing an adaptive modulation scheme, comprising the steps of:
performing symbol processing for each slot;
detecting a value indicating a changing state of a propagation path between the another communication apparatus and the communication apparatus;
changing the symbol to a control symbol based on the value indicating the changing state detected at the step for detecting the value and a modulation scheme in the communication between the another communication apparatus and the communication apparatus; and
transmitting a communication frame after control at the step for changing the symbol to the another communication apparatus.
